(19) United States
(12) Patent Application Publication
(10) Pub. No.: US 2007/0106586 A1
(43) Pub. Date: May 10, 2007

(54) System and method for monitoring physical assets

(76) Inventor: Steven Mack, Reno, NV (US)

Correspondence Address: Bernhard Kreten;Weintraub Genshlea Chediak, 11th Floor, 400 Capitol Mall, Sacramento, CA, 95814, US

(21) Appl. No.: 11/268,866

(22) Filed: Nov. 7, 2005

(51) Int. Cl. G06Q 40/00

(52) U.S. Cl. 705/36 R

(57) ABSTRACT

A system and method for monitoring physical assets. An asset is registered at a site and simultaneously appraised for value. The registered asset is periodically evaluated over time to estimate and record value fluctuations in the asset. Upon request, the asset's current value is reported. Asset owners are periodically offered new or upgraded versions of existing registered assets, and a time and quality dependent buy-back voucher in the amount of the registered asset's current estimated value based on the asset in question conforming to the valuation algorithm. The buy-back voucher may be redeemed at the appropriate retail establishment.

### FIELD OF THE INVENTION

The following invention is generally directed to monitoring the value of physical assets. Specifically, the instant invention chronicles and records an asset's value over time for future consideration or asset disposition.

### BACKGROUND OF THE INVENTION

The acquisition and use of consumer goods, related services and other such physical assets necessarily leads to value fluctuations for those assets over time. An asset's value may change over a short period of time, and virtually the instant an asset purchase is consummated, the asset's value is subject to market depreciation. Asset value undoubtedly changes over longer periods of time, and any number of factors may combine to influence an asset's value, including asset age, market fluctuations, the asset's internal and external condition, and whether the asset has become obsolete due to commercial availability of new or better versions of the initially purchased asset.

At any point during the life of an asset, an asset owner may encounter circumstances requiring an efficient, accurate and current asset valuation. For example, an asset may be destroyed due to fire, flood or other catastrophic event; or lost, stolen or damaged beyond repair. Under these circumstances, a current value determination for the lost or destroyed asset would assist the owner in recouping the asset's value via insurance, warranty or other replacement mechanisms. Alternatively, an asset may become subject to disposition as a function of divorce or probate proceedings, or be used as a charitable donation to a worthy cause. Here, an accurate and current asset valuation may be necessary to effectuate asset disposition. Conversely, an asset owner may simply desire to replace an existing asset, such as a computer, television, home appliance or yard tool, with a new and improved asset version that becomes available in the marketplace. Under these circumstances, the asset owner may wish to assess the existing asset's current value for resale, the proceeds from which the upgraded asset will be purchased.

Despite the fact that commerce is now more robust, frequent, and lucrative than ever before in world history, a simple and accurate system for maintaining asset value records does not exist. Without maintaining an accurate record of an asset's value over the life of the asset, accurately determining the asset's value upon loss or destruction is virtually impossible. Unsophisticated and inaccurate valuation formulas are usually applied after-the-fact and without the benefit of physically evaluating the asset's actual condition prior to the event triggering valuation. In addition, asset owners operate from an economically disadvantaged purchasing stance when deciding whether to upgrade or replace an asset without an accurate record of the existing asset's value for resale, exchange, or other such purposes. Moreover, an asset owner's decision to upgrade or replace existing assets is often haphazard or spontaneous, and results from hit-or-miss encounters with new asset versions, instead of a systematic and efficient manner of identifying new asset versions; and receiving maximum value for existing assets in exchange for such new assets.

A system is needed that has the combined benefits of centralized asset registration, coupled with centralized expert data systems to report the current value of registered assets; notify asset registrants when new asset versions become available in the marketplace; and facilitate an asset registrant's disposal of old assets and acquisition of new or upgraded assets.

### SUMMARY OF THE INVENTION

The system is comprised of multiple technologies utilizing diverse asset identification and categorization channels to register existing and newly acquired assets into the system's asset registration databank. The system comprises multiple “storefronts” to allow physical operation in strategically designated locations, coupled with an online presence to facilitate electronic asset registration and categorization in the system's organizational hierarchy. The system also provides a sophisticated asset value estimator and recorder, which periodically chronicles asset value as a function of time, and changes in commodity values in the case of jewelry, in conjunction with various other factors known to influence asset market value. The system is capable of generating current value reports for registered assets upon the occurrence of any number of external stimulants that require asset value reporting. The system also contains a current library of new or upgraded versions of assets that become available in the marketplace, which correspond in-kind to assets registered in the system. The system provides a trade-in paradigm for registered assets, and facilitates system registrants in replacing registered assets with new or upgraded asset versions as they become commercially available.

### OBJECTS OF THE INVENTION

A primary object of the present invention is to provide a new and novel system and method for monitoring physical assets.

Viewed from a first vantage point, it is an object of the present invention to provide a system for monitoring an asset, the system comprising, in combination: a means for establishing a base value for the asset; a means for chronicling the evolution of the asset's value as a function of time, changes in commodity values in the case of jewelry, and other factors relevant to asset value determination; and a means for reporting the asset's value as a function of a plurality of external stimulants.

Viewed from a second vantage point, it is an object of the present invention to provide a system for monitoring an asset, the system comprising, in combination: a means for establishing a base value for the asset, said establishing means including a plurality of questions stored in a preprogrammed asset profile to be completed during asset registration into the system, said questions including a choice of possible answers if the universe of possible answers is known, and an appraisal weighing template utilizing internal tables to estimate appraisal determinations; a means for chronicling the evolution of the asset's value as a function of time, changes in commodity values in the case of jewelry, and other factors relevant to asset value determination; and a means for reporting the asset's value as a function of a plurality of external stimulants.

Viewed from a third vantage point, it is an object of the present invention to provide a system for monitoring an asset, the system comprising, in combination: a means for establishing a base value for the asset; a means for chronicling the evolution of the asset's value as a function of time, changes in commodity values in the case of jewelry, and other factors relevant to asset value determination, said chronicling means including a periodic system-generated prompt requesting reevaluation of an asset's condition based on a plurality of preprogrammed questions regarding current asset condition, a physical display of said asset to confirm asset condition, an appraisal weighing template utilizing internal tables to estimate and record adjusted asset value determinations; and a means for reporting the asset's value as a function of a plurality of external stimulants.

Viewed from a fourth vantage point, it is an object of the present invention to provide a system for monitoring an asset, the system comprising, in combination: a means for establishing a base value for the asset; a means for chronicling the evolution of the asset's value as a function of time, changes in commodity values in the case of jewelry, and other factors relevant to asset value determination; and a means for reporting the asset's value as a function of a plurality of external stimulants, said reporting means including retrieval of a pre-registered asset profile, adjustment of the asset's value based on a plurality of value modifiers, and computation and recordation of the asset's adjusted value.

Viewed from a fifth vantage point, it is an object of the present invention to provide a system for monitoring an asset, the system comprising, in combination: a means for establishing a base value for the asset; a means for chronicling the evolution of the asset's value as a function of time, changes in commodity values in the case of jewelry, and other factors relevant to asset value determination; and a means for reporting the asset's value as a function of a plurality of external stimulants, said means including retrieval of a pre-registered asset profile, adjustment of the asset's value based on a plurality of value modifiers, and computation and recordation of the asset's adjusted value, and wherein one external stimulant requiring asset value reporting is selected from the group, including tax depreciation, natural catastrophes, home invasion, fire, divorce, death, resale, and charity donation.

Viewed from a sixth vantage point, it is an object of the present invention to provide a system for monitoring an asset, the system comprising, in combination: a means for establishing a base value for the asset; a means for chronicling the evolution of the asset's value as a function of time, changes in commodity values in the case of jewelry, and other factors relevant to asset value determination; a means for reporting the asset's value as a function of a plurality of external stimulants; and a means for offering a system registrant a different asset in place of a registered asset.

Viewed from a seventh vantage point, it is an object of the present invention to provide a system for monitoring an asset, the system comprising, in combination: a means for establishing a base value for the asset; a means for chronicling the evolution of the asset's value as a function of time, changes in commodity values in the case of jewelry, and other factors relevant to asset value determination; a means for reporting the asset's value as a function of a plurality of external stimulants; and a means for offering a system registrant a different asset in place of a registered asset, said offering means including a library of currently available commercial assets, comparison and matching of assets in the library with a plurality of registered asset profiles, an appraisal weight template utilizing internal tables to estimate and adjust the registered asset's current value, and provision of a redeemable voucher for the registered asset's value in exchange for title to the registered asset.

Viewed from an eighth vantage point, it is an object of the present invention to provide a system for monitoring an asset, said system comprising, in combination: a historical database; and a communication terminal, wherein said historical database and communication terminal are operatively connected to facilitate the exchange of information regarding the asset.

Viewed from a ninth vantage point, it is an object of the present invention to provide a system for monitoring an asset, said system comprising, in combination: a historical database; and a communication terminal, wherein said historical database and communication terminal are operatively connected to facilitate the exchange of information regarding the asset, and wherein said communication terminal is programmed to receive and process information regarding the asset, to create a report of information regarding the value of the asset, and display or generate said report.

Viewed from a tenth vantage point, it is an object of the present invention to provide a method for monitoring the value of an asset, the steps including: establishing a base value for the asset; chronicling the evolution of the asset's value as a function of time and a plurality of value influencing factors; reporting the asset's value as a function of a plurality of external stimulants; and replacing the asset with a different asset.

Viewed from an eleventh vantage point, it is an object of the present invention to provide a method for establishing the value of an asset, the steps including: registering asset information into as electronic database; creating an asset profile for the asset based upon evaluation of a plurality of questions regarding the asset's value; and comparing said asset profile against an appraisal weighing template utilizing internal tables to formulate asset value estimates.

Viewed from a twelfth vantage point, it is an object of the present invention to provide a method for electronically replacing pre-owned assets, the steps including: registering asset information into a database; creating an asset profile for the asset based upon evaluation of a plurality of questions regarding the asset's value; comparing said asset profile against an appraisal weighing template utilizing internal tables to formulate and adjust asset value estimates; comparing said asset profile against identical or similar assets stored in a library of currently available commercial assets; and providing a system registrant with a redeemable voucher for the asset valued in said asset profile in exchange a similar currently available commercial asset.

These and other objects will be made manifest when considering the following detailed specification when taken in conjunction with the appended drawing figures.

### BRIEF DESCRIPTION OF THE DRAWINGS

FIG. 1 shows a block diagram of a computer system according to the present invention.

FIG. 2 shows a flow chart overview of the inventive method.

FIG. 3 shows a flow chart of the asset replacement method.

### DESCRIPTION OF PREFERRED EMBODIMENTS

Referring to the drawings, wherein like numerals denote like parts throughout the various drawing figures, reference numeral 10 is directed to the system for monitoring physical assets according to the present invention.

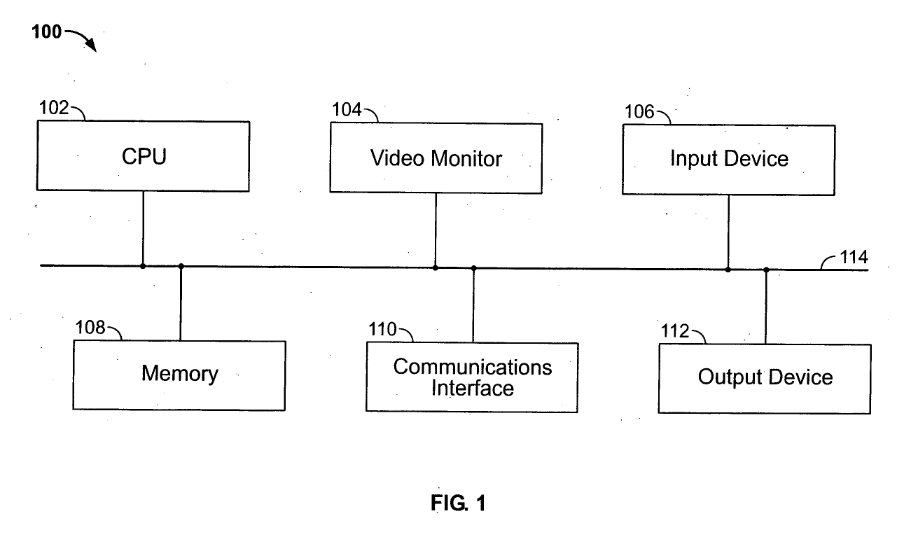

Referring now to FIG. 1, a computer (100) is shown according to the present invention. Computer (100) preferably comprises a central processing unit (CPU) (102), a video monitor (104), an input device (106), a memory (108) comprising a historical database of asset value information, a communications interface (110), and an output device (112). Each component of computer (100) is preferably coupled to a common system bus (114). CPU (102) receives, processes and outputs a record of asset value information as more fully set forth below.

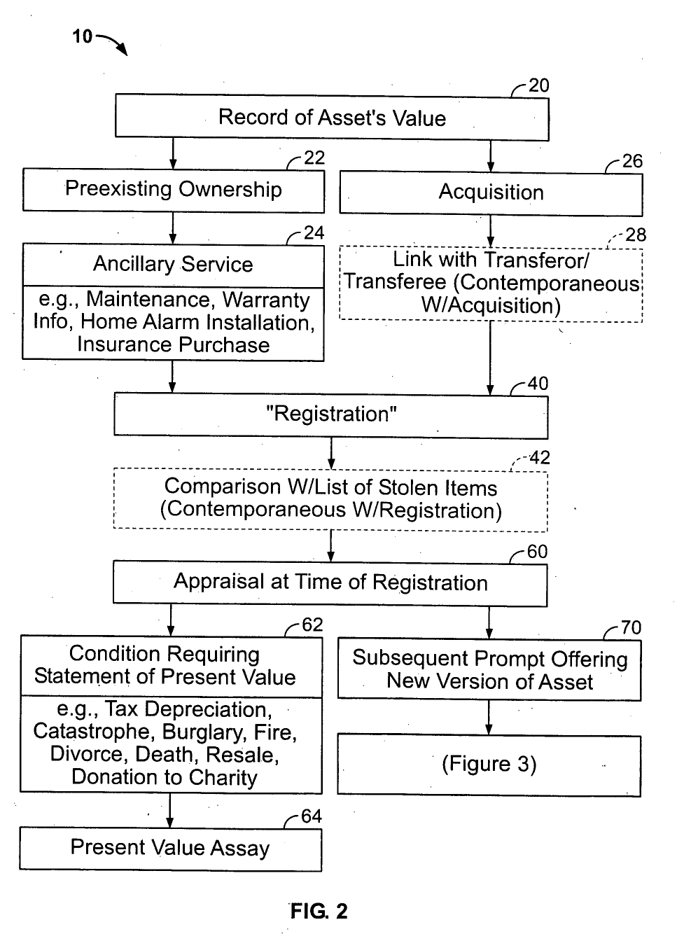

Referring now to FIG. 2, illustrated is an overview of the present system, which allows the average person of ordinary means to establish and maintain a record of personal, household, recreational, and other physical assets 20, by having those assets registered 40 in the system 10 by a qualified system operator. The asset value record 20 created and maintained by the system 10 is useful for various reasons.

First, the asset value record 20 created and maintained by the system 10 can be used to establish a registered asset's present value 64. A plethora of external stimulants 62 may occur that require an analysis of a registered asset's present value 64. For instance, a registered asset may be lost, stolen, or destroyed by fire, flooding or other catastrophe. Alternatively, a registered asset may experience reportable tax depreciation, or be the subject of resale or disposition due to death, divorce, or charity donation. Upon the occurrence of these, or a host of other, external stimulants 62, the system 10 will provide the asset owner with a record of the asset's present value 64, which the owner can use to replace the asset, or recoup its value by way of insurance or other coverage resources.

Second, the system 10 asset value record 20 can be used to determine whether the asset owner wishes to replace or upgrade a registered asset. For instance, a registered asset may be subject to warranty, maintenance, or other ancillary service events 24. Upon an ancillary service contract event 24, including expiration or lapse of the ancillary service contact 24, an asset owner may wish to replace or upgrade the registered asset.

Alternatively, separate and apart from an ancillary service event 24, an upgraded or improved version of a registered asset may become available in the marketplace unbeknownst to the asset owner. Here again, the asset owner may wish to upgrade or replace the registered asset with a corresponding new and improved version.

To facilitate asset replacement and upgrading, contemporaneous with an asset's registration 40 in the system 10, ancillary service information 24 pertaining to each individual asset is entered into the system 10 registration database 40. Additionally, the system 10 registration database 40 is periodically updated to include upgraded or otherwise improved versions of currently registered assets, including, for example, televisions, home and garden appliances, home security systems, automobiles, and a vast array of other commercially available assets. Before and upon the occurrence of an ancillary service event 24, or upon commercial introduction of an upgraded or improved product corresponding to a registered asset, the system 10 generates a prompt 70, which offers the registered asset owner the new or upgraded version of a registered asset.

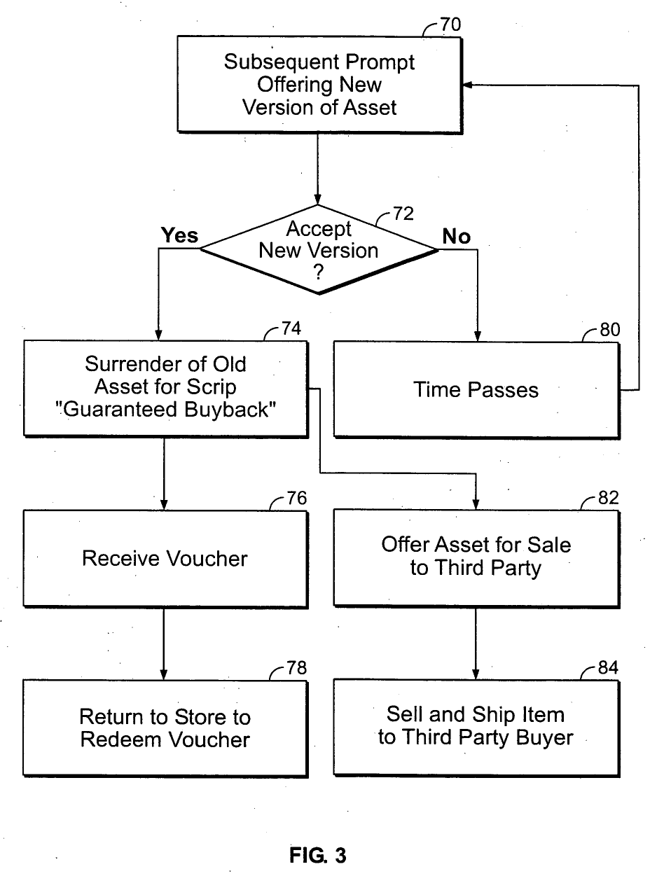

Referring to FIG. 3, the system 10 generates a prompt 70 offering a registered asset owner a new version of the registered asset. The registered asset owner can either accept or decline the new asset version 72. If the asset owner declines the new asset version, after a designated period of time passes 80, the system 10 will regenerate a prompt 70 offering the asset owner a new version of the registered asset. If the registered asset owner accepts the new asset version, the system 10 offers the registered asset owner a guaranteed buyback scrip voucher 74 for the old registered asset, based on the registered asset's present value, upon surrender of the old registered asset to the system 10 operator. The system 10 will generate an asset scrip voucher 74 in the guaranteed buyback amount and forward that voucher to the asset owner 76 upon surrender of the old asset. The asset owner will then return to the establishment from which the old asset originated and redeem the asset scrip voucher 78. The system 10 operator then offers the asset for sale to a third party 82, either electronically or via in-store transaction. Upon consummation of the old registered asset sale, that asset is then shipped to its new owner from the store 84. This model efficiently facilitates the sale of old assets in what has become a vast secondary market for used commercial goods.

### Asset Registration

Assets may be registered in the system 10 registration database 40 either after they have been purchased (i.e., preexisting ownership) 22, or simultaneous with initial asset acquisition 26. For assets of preexisting ownership 22 and newly acquired assets 26, asset registration 40 may occur in a number of ways, as discussed more fully below. The asset registration information is used to appraise the value of assets 60 upon registration into the system 10 registration database 40, to chronicle the evolution of the asset's value over time, to determine the asset's present value 64 at future time points when necessary, and to identify upgrades and new versions of registered assets.

In one embodiment of the invention, assets of preexisting ownership 22 are categorized and registered into the registration system 40 registration database electronically by the system 10 operator after the asset owner applies for registration in the system 10 at a secured online registration site. The online asset registration site may be owned and maintained by local stores housing the system 10 and corresponding operators. At the secured online asset registration site, an asset owner is offered a registration screen that simultaneously creates an asset identification profile for the asset owner; assigns the asset owner an asset identification profile number; and prompts the asset owner to supply detailed information describing the assets to be registered. To describe an asset, an asset owner chooses from specific predefined categories listed on the system 10 online registration database 40 screen. Item categories are arranged in a four-level descriptive hierarchy, consisting of Area, Department, Class, and Style (ADCS). In this hierarchy, styles are grouped into classes, classes are grouped into departments, and departments are grouped into one of three areas: manufactured items, jewelry, and system services (such as home and automobile alarm systems and the like).

In describing the asset to be registered, the asset owner selects from a series of predefined identifiers presented on the system 10 registration database 40 screen, which are arranged from the top down in the ADCS hierarchy. The asset owner first selects the appropriate item area for the particular asset to be registered, then the asset's department, and finally the more detailed asset information regarding class and style. For example, suppose that an asset owner applies online to register in the registration database 40 a common manufactured item, such as a Sony KD-34XS955 34-inch Widescreen FD Trinitron HDTV television. In describing the asset, the asset owner will select the Area “Manufactured Good”, the Department “Consumer Electronics”, the Class “Television”, and the Style “Conventional Widescreen Television”. At this point, the asset owner will be prompted to select a manufacturer from a predefined list exclusively containing conventional widescreen television manufacturers. The asset owner will then select television manufacturer “Sony Corporation” from the list. All model numbers for Sony widescreen televisions will then be generated, one of which will be the KD-34XS955 model.

After entering the required asset identification information, the registration database 40 of the present invention will present the asset owner with a series of questions relating to any ancillary services 24 that exist corresponding to the particular asset. For instance, the registration database 40 screen for each asset profile will prompt the asset owner to input any information identifying and describing any warranty agreements, maintenance agreements, service plans, insurance coverage, or other ancillary service 24 relating to each asset being registered into the registration database 40.

After entering information regarding ancillary services 24 relating to the asset, the registration database 40 screen for each asset profile will require the asset owner to answer a series of questions relating to the asset's age and condition, including the asset's purchase date, whether the asset was purchased new or used, the existence of external or internal asset blemishes, whether the asset as ever been damaged in any way, and the like. Additionally, for online registration the asset owner will be required to submit a digital photograph of each asset being registered, both to verify the existence of the asset and to assess the asset's value as discussed more fully below.

As an alternative to online asset registration, a system 10 operator or an authorized agent will meet in-person with the asset owner at the location housing assets to be registered in the registration database 40. The authorized agent will inventory the assets to be registered, and via a remote access device employing the registration database 40 criteria previously discussed, enter each asset into the registration database 40.

Newly acquired assets may be registered in the registration database 40 contemporaneously with acquisition, including both in-store and online purchases. Virtually all retail establishments sell products that have unique product codes, called UPC codes in the United States, and EAN codes in most other countries. The code, referred to as ‘UPC code’ in this document, is usually printed on the outside of an asset's package as a bar code. This numeric product code uniquely identifies the product, including ADCS category, Manufacturer and Mode. For an in-store purchase, upon an asset purchaser's pre-approval, the purchaser's personal identification information, and bar code information scanned into the retail establishment's register at the time of purchase, are simultaneously forwarded to the registration database 40, which generates a prompt for the system 10 operator to clear that asset for registration, as discussed more fully below. Along with the electronically submitted bar code information identifying the asset and asset purchaser, all information concerning any ancillary services the asset purchaser acquired in conjunction with a particular asset is also forwarded to the registration database 40.

With respect to online purchases, upon consummation of a purchase and with an asset owner's pre-approval, the asset purchaser's personal identification information, asset bar code information, and any related ancillary service information are electronically and simultaneously forwarded to the system 10 operator for ultimate registration in the registration database 40. Using UPC bar code information to identify registered assets avoids the necessity for manual information input, and reduces the likelihood of input errors that occur more frequently with manual data entry.

Regardless of which asset registration model is used, once an asset is submitted for registration, the registration database 40 automatically compares the registration request against a known list of lost or stolen items 42 prior to the system 10 operator clearing the asset for registration in the registration database 40. Each individual store housing the system 10 and corresponding system operators can be connected by server to a centralized location having a security databank library of lost or stolen goods, which processes the asset registration information, and via server, transmits and communicates the process results from the centralized location to individual stores nationwide. By processing each asset through the security databank library, the registration database 40 simultaneously verifies the asset owner's title to each particular asset.

### Asset Appraisal at Time of Registration

Once an asset is registered, either electronically or manually, the asset simultaneously undergoes a valuation process that determines the asset's base value 60. Assume for newly purchased items that the asset's base value is the purchase price at the time of purchase for simultaneous registration in the registration database 40. For assets of preexisting ownership, the asset's base value is computed using predetermined factors, including those factors for which an asset owner supplied information during the registration process as discussed above. Specifically, during the registration process, the asset owner answers a series of questions relating to the asset's age and condition, including the asset's purchase date, whether the asset was purchased new or used, the existence of external or internal asset blemishes, whether the asset was ever damaged in any way, and the like. Additional parameters are also used in determining the asset's value, including historical pricing, fallout rates, sales turnover rates, and market conditions.

The system 10 registration database 40 uses internal tables, in the form of model templates, to compute the asset's base value based upon parameters such as those previously discussed. Specifically, the system 10 registration database 40 contains a library of model templates for a wide variety of commercially available assets. Each asset represented in a model template is categorized in the ADCS hierarchy discussed above, including manufacturer identification and model number. Also included in the model template is the asset's historical pricing information, and a series of questions identical to those questions answered by the asset owner during the registration phase. Each of the questions contained in the model template relates to the nature of the asset's quality and therefore potentially impacts the asset's value. Each question has been weighted to reflect its potential impact on the asset's value. The asset owner's answers to these questions, which are imported into the model template from the registration application, determine the percent impact those answers will have on the asset's value. The total percentage impact resulting from answers to all weighted questions will be used to adjust the model asset price. The adjusted model asset price becomes the registered asset's base value. The model template, containing the registrant's imported asset information and computed base price, is renamed and filed as an asset profile in the registrant's asset file portfolio.

### Present Value Determination of Registered Assets

Once assets are registered into the system 10 registration database 40 and each asset's base value is determined, the asset's value may be determined as a function of time, changes in commodity values in the case of jewelry, and other factors relevant to asset value determination at any point in the future. Each asset profile, comprising individual asset identification and base value information, contains asset appropriate multipliers, which are used to adjust an asset's value by taking into account asset appreciation or depreciation as a function of time and changes in commodity values in the case of jewelry, as well as the asset's then current condition. The multipliers are specific to the nature of the asset, as identified primarily by the asset's ADCS information. In the asset profile, an asset's base value is multiplied by the appropriate multiplier to determine the asset's present value at any point after initial asset registration and base value determination.

Registered assets may also be periodically reevaluated over time to chronicle the asset's value. The system 10 is programmed to generate a prompt at predetermined time intervals over the life of each registered asset, at predetermined changes in value and/or upon the release of a newer, similar asset. Upon receiving the prompt for a specific asset, the system 10 operator notifies the asset registrant that asset reevaluation is required, and requests the registrant to select any one of a variety of options for completing asset reevaluation. For instance, the asset registrant may complete asset reevaluation by answering a series of predetermined questions regarding the asset's quality, and forwarding the system operator a current digital photograph of the registered asset, clearly depicting the asset's then current condition. Alternatively, the asset registrant may request that a system operator come to the asset's location in-person and evaluate the asset's condition.

Once an asset's current condition is evaluated, corresponding modifiers in the asset's profile are multiplied against the asset's base value to determine the asset's current value. Once an asset's current value is adjusted, taking into consideration asset appreciation or depreciation, asset conditions market value, and the like, the adjusted asset value is documented in a running record of the asset's value maintained in the asset profile.

### Reporting Asset Value as a Function of External Stimulants

The system 10 is capable of reporting an asset's value when such a report is necessary due to the occurrence of a variety of external stimulants 62 that may occur regarding a particular asset. For instance, a registered asset may be destroyed in a fire, rain storm, flood, or other event of nature. Alternatively, a registered asset may be lost, stolen, or otherwise removed from a registrant's possession without the registrant's authorization. On the other hand, the asset registrant may need to dispose of a registered asset due to divorce, death or similar triggering event. An asset registrant may also desire to dispose of a registered asset by charity donation or resale. Upon the occurrence of one of these events, or a myriad of other possible scenarios, the registrant may require a report of a registered asset's current value. Upon request, a system 10 operator will retrieve the correct asset profile, adjust the asset's base value with the appreciation, depreciation, and market value multipliers as discussed above, and compute the asset's current value. The system 10 operator will then generate a report containing the asset's current value and the asset's value history record that was developed over time as discussed above.

### Asset Replacement and Upgrading

The system 10 includes a library of UPC codes and other available product identification information for a vast variety of commercially available products and services. The system 10 product library is updated continuously to add both new versions of products previously entered into the library, and new products that enter the market that have not yet been added to the product library. UPC code information, including ADCS category, manufacturer, model number, and other available product identification information may be entered into the system 10 product library manually, but preferably such information is simply scanned into the system 10 product library via UPC bar code scanning or other electronically suitable manner.

The system 10 routinely scans the updated product library against asset profiles maintained in the registration database 40. When new product identification information, including ADCS information, matches a registered asset's category, the system 10 recognizes the match and generates a prompt 70. The prompt 70 generated upon matching a registered asset's category and a new product version notifies the registrant that a new product version is available, and offers the registrant an opportunity to purchase the new asset version. Alternatively, the prompt 70 generated when a match is made been a registered asset and a new product notifies the system 10 operator that a new product version is available, and the system 10 operator then contacts the registrant and offers the new product version.

Referring to FIG. 3, the prompt 70 generated when a match is made between a registered asset and a new product provides a description of the new product, including price; gives the registrant a choice of either accepting or rejecting the new version 72; and offers the registrant a guaranteed buyback asset scrip voucher 74, in the amount of the registered asset's current, as determined above, in exchange for title to the registered asset. If the registrant accepts the new product version, arrangements are made for the registrant to exchange the registered asset for the guaranteed buy back asset scrip voucher 74. The registrant may then return to the commercial establishment offering the new product version and redeem the asset scrip voucher 78. Upon acquisition, the new product version is registered into the registration database 40 as discussed above.

The old registered asset is then offered for sale to a third party 82 based upon the asset's current value, as determined above. The sale may be consummated either electronically, such as by internet auction, or in the store in which the asset is being displayed. Upon consummation of a sale, the old registered asset profile is updated to identify the third party buyer and resubmitted into the registration database 40. The asset is then packaged and shipped to the third party buyer 84.

In addition to offering replacement assets, the system 10 routinely scans the updated product library against asset profiles to match registered assets with ancillary, complimentary products that are or become commercially available. Using higher level ADCS category identifiers and other such product identification information entered into the new product library, the system 10 recognizes commercially available products that can conceivably be used complimentarily in conjunction with existing registered assets. For example, registrants whose assets comprise a computer may receive a prompt offering a complimentary new laser printer; registrants whose assets comprise a television entertainment system may receive a prompt offering complimentary hi-fidelity surround sound components; registrants whose assets comprise exercise equipment may receive a prompt offering complimentary fitness implements, and so on. The prompt 70 generated upon matching a registered asset's category and a complimentary new product's category notifies the registrant that an ancillary, complimentary product is available, and offers the registrant an opportunity to purchase the ancillary, complimentary asset. Alternatively, the prompt 70 notifies the system 10 operator that an ancillary, complimentary product for potential use with a registered assed is commercially available, and the system 10 operator then contacts the registrant and offers the new ancillary, complimentary product. As with new product versions discussed above, the prompt 70 gives registrants an opportunity to either accept or reject the new ancillary, complimentary product and allows the registrant to purchase a voucher 76 for the new ancillary, complimentary product, which in some cases with reflect a discounted amount pre-arranged by the system 10 operator and the relevant retail establishment based on prior business relations. If the registrant rejects the offer, the prompt 70 is re-generated after a designated period of time passes, and again offers the registrant an opportunity to purchase new ancillary, complementary products in conjunction with, or in addition to, registered assets.

It is noteworthy that the present invention is virtually self-contained. Essentially all of the functions of the present invention are carried out using the database discussed above, including, but not limited to: registering and categorizing assets; appraising asset value both initially upon registration and over the life of registered assets; reporting asset value when requested; and facilitating asset replacement and subsequent disposal of old registered assets on the secondary market.

### Functionality Changes

Having thus described the invention, it should be apparent that numerous structural modifications and adaptations may be resorted to without departing from the scope of the instant invention as set forth hereinabove and as defined below by the claims.

I claim:

1. A system for monitoring an asset, said system comprising, in combination:
(a) a means for establishing a base value for the asset;
(b) a means for chronicling the evolution of the asset's value as a function of time; and
(c) a means for reporting the asset's value as a function of a plurality of external stimulants.

2. A system for monitoring an asset, said system comprising, in combination:
(a) a means for establishing a base value for the asset,
said means for establishing a base value for the asset including a plurality of questions stored in a preprogrammed asset profile to be completed during asset registration into the system, said questions including a choice of possible answers if the universe of possible answers is known, and an appraisal weighing template utilizing internal tables to estimate appraisal determinations;
(b) a means for chronicling the evolution of the asset's value as a function of time; and
(c) a means for reporting the asset's value as a function of a plurality of external stimulants.

3. A system for monitoring an asset, said system comprising, in combination:
(a) a means for establishing a base value for the asset;
(b) a means for chronicling the evolution of the asset's value as a function of time,
said means for chronicling the evolution of the asset's value as a function of time including a periodic system-generated prompt requesting reevaluation of the asset's condition based on a plurality of preprogrammed questions regarding current asset condition, a physical display of the asset to confirm asset condition, an appraisal weighing template utilizing internal tables to estimate and record adjusted asset value determinations; and
(c) a means for reporting the asset's value as a function of a plurality of external stimulants.

4. A system for monitoring an asset, the system comprising, in combination:
(a) a means for establishing a base value for the asset;
(b) a means for chronicling the evolution of the asset's value as a function of time; and
(c) a means for reporting the asset's value as a function of a plurality of external stimulants,
said means for reporting the asset's value as a function of a plurality external stimulants including retrieval of a pre-registered asset profile, adjustment of the asset's value based on a plurality of value modifiers, and computation and recordation of the asset's adjusted value.

5. The system of claim 4 wherein one external stimulant requiring asset value reporting is selected from the group, including tax depreciation, natural catastrophes, home invasion, fire, divorce, death, resale, and charity donation.

6. A system for monitoring an asset, said system comprising, in combination:
(a) a means for establishing a base value for the asset;
(b) a means for chronicling the evolution of the asset's value as a function of time;
(c) a means for reporting the asset's value as a function of a plurality of external stimulants; and
(d) a means for offering a system registrant a different asset in place of a registered asset.

7. A system for monitoring an asset, said system comprising, in combination:
(a) a means for establishing a base value for the asset;
(b) a means for chronicling the evolution of the asset's value as a function of time;
(c) a means for reporting the asset's value as a function of a plurality of external stimulants; and
(d) a means for offering a system registrant a different asset in place of a registered asset,
said means for offering a system registrant a different asset in place of a registered asset including a library of currently available commercial assets, comparison and matching of assets in the library with a plurality of registered asset profiles, an appraisal weighing template utilizing internal tables to estimate and adjust the registered asset's current value, and provision of a redeemable voucher for the registered asset's value in exchange for title to the registered asset.

8. A system for monitoring an asset, said system comprising, in combination:
(a) a historical database; and
(b) a communication terminal,
wherein said historical database and communication terminal are operatively connected to facilitate the exchange of information regarding the asset.

9. The system of claim 8 wherein said communication terminal is programmed to receive and process information regarding the asset, to create a report of information regarding the value of the asset, and display or generate said report.

10. A method for monitoring the value of an asset, the steps including:
(a) establishing a base value for the asset;
(b) chronicling the evolution of the asset's value as a function of time and a plurality of value influencing factors;
(c) reporting the asset's value as a function of a plurality of external stimulants; and
(d) replacing the asset with a different asset.

11. A method for establishing the value of an asset, the steps including:
(a) registering asset information into an electronic database;
(b) creating an asset profile for the asset based upon evaluation of a plurality of questions regarding the asset's value; and
(c) comparing said asset profile against an appraisal weighing template utilizing internal tables to formulate asset value estimates.

12. A method for electronically replacing pre-owned assets, the steps including:
(a) registering asset information into a database;
(b) creating an asset profile for the asset based upon evaluation of a plurality of questions regarding the asset's value;
(c) comparing said asset profile against an appraisal weighing template utilizing internal tables to formulate and adjust asset value estimates;
(d) comparing said asset profile against identical or similar assets stored in a library of currently available commercial assets; and
(e) providing a system registrant with a redeemable voucher for the asset valued in said asset profile in exchange a similar currently available commercial asset.
